(19) United States
(12) Patent Application Publication
(10) Pub. No.: US 2017/0328390 A1
(43) Pub. Date: Nov. 16, 2017

(54) Animal Pen Retention System

(71) Applicants: Morton Evans, Santa Anna, CA (US); Beverly Evans, Santa Anna, CA (US)

(72) Inventors: Morton Evans, Santa Anna, CA (US); Beverly Evans, Santa Anna, CA (US)

(21) Appl. No.: 15/152,550

(22) Filed: May 12, 2016

(51) Int. Cl. F16B 2/22; A01K 1/02; A01K 29/00; E05F 5/00

(52) U.S. Cl. CPC F16B 2/22; E05F 5/00; A01K 1/02; A01K 29/00

(57) ABSTRACT

An animal pen retention system includes a collapsible animal cage that has a plurality of walls. Each of the walls is hingedly coupled together. Thus, the collapsible animal cage is positionable in a deployed position having the collapsible animal cage forming an enclosed geometric shape. A plurality of clips is provided. Each of the clips is positionable on the walls when the collapsible animal cage is positioned in the deployed position. Thus, each of the clips inhibits the collapsible animal cage from being urged out of the deployed position.

### BACKGROUND OF THE DISCLOSURE

### Field of the Disclosure

The disclosure relates to retention devices and more particularly pertains to a new retention device for retaining a collapsible animal cage in a deployed position.

### SUMMARY OF THE DISCLOSURE

An embodiment of the disclosure meets the needs presented above by generally comprising a collapsible animal cage that has a plurality of walls. Each of the walls is hingedly coupled together. Thus, the collapsible animal cage is positionable in a deployed position having the collapsible animal cage forming an enclosed geometric shape. A plurality of clips is provided. Each of the clips is positionable on the walls when the collapsible animal cage is positioned in the deployed position. Thus, each of the clips inhibits the collapsible animal cage from being urged out of the deployed position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of an animal pen retention system according to an embodiment of the disclosure.

FIG. 2 is a front view of an embodiment of the disclosure.

FIG. 3 is a bottom view of an embodiment of the disclosure.

FIG. 4 is a back view of an embodiment of the disclosure.

FIG. 5 is a perspective in-use view of an embodiment of the disclosure.

FIG. 6 is a bottom perspective view of an embodiment of the disclosure.

### DESCRIPTION OF THE PREFERRED EMBODIMENT

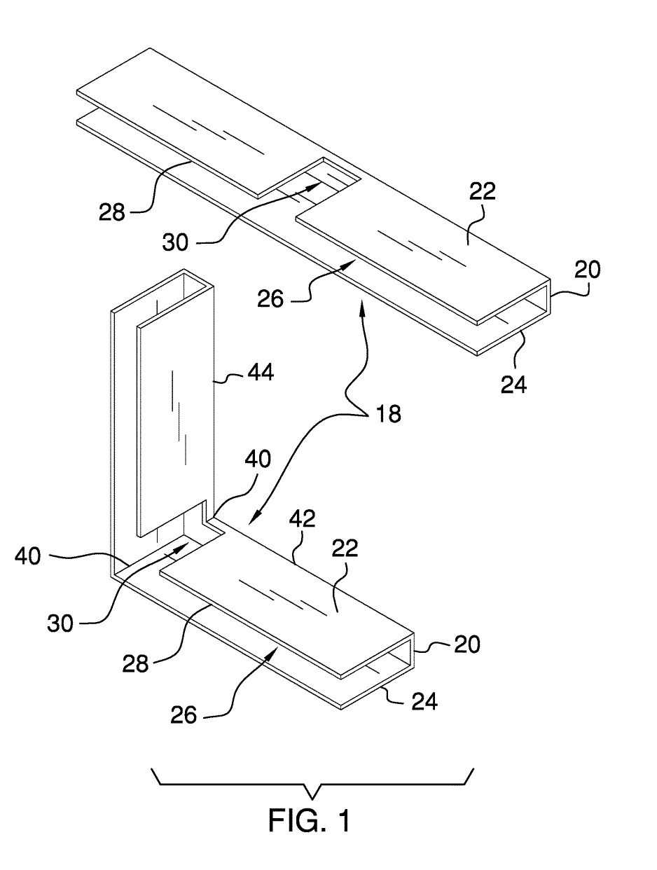

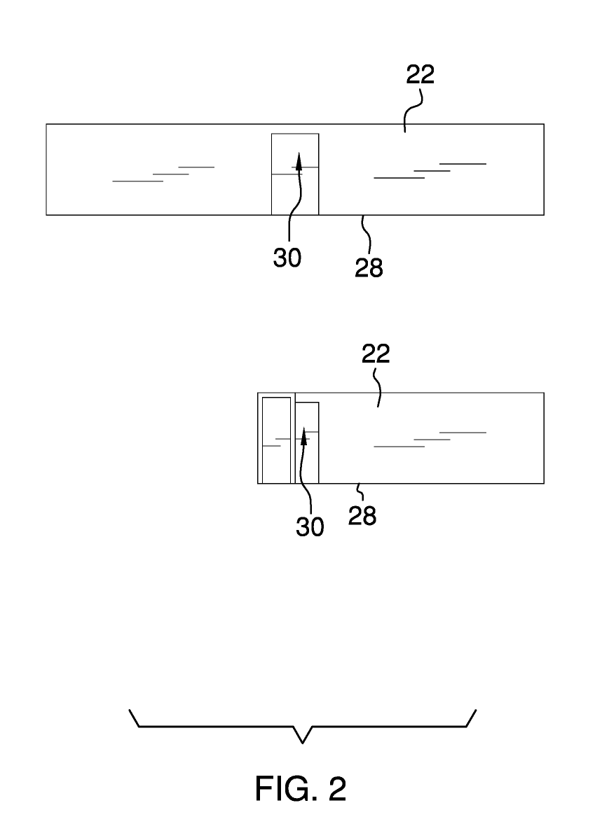

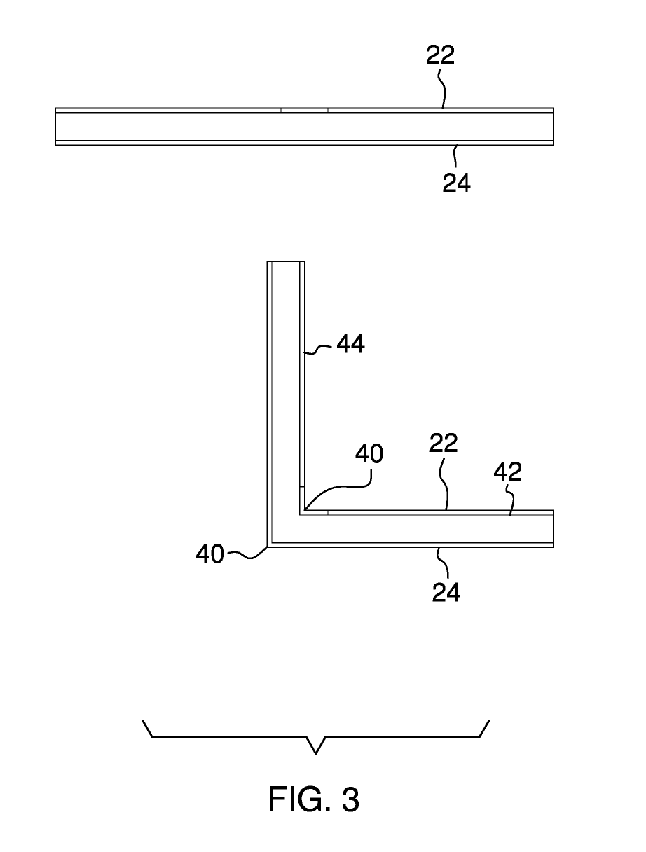

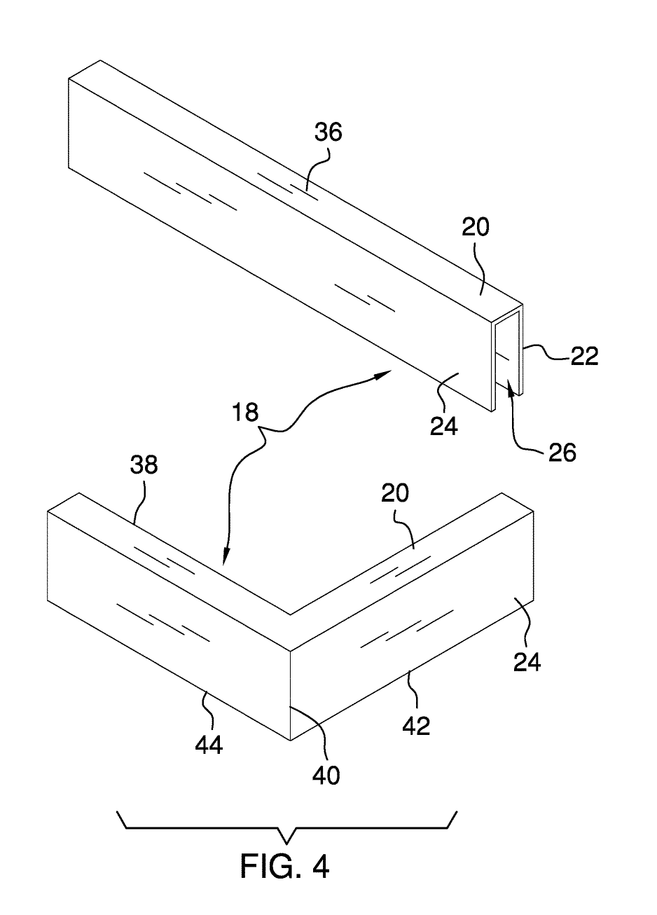

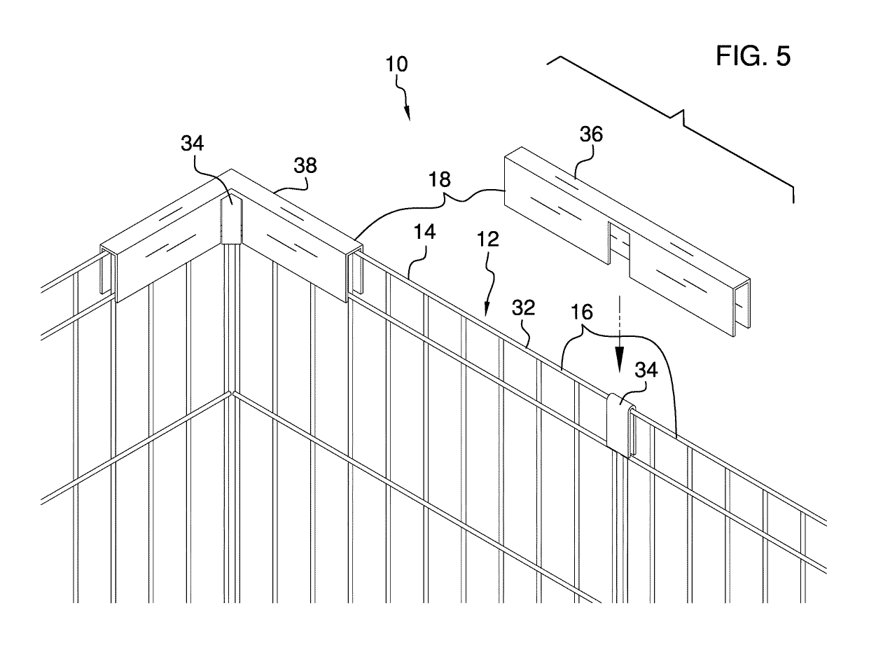

With reference now to the drawings, and in particular to FIGS. 1 through 6 thereof, a new retention device embodying the principles and concepts of an embodiment of the disclosure and generally designated by the reference numeral 10 will be described.

As best illustrated in FIGS. 1 through 6, the animal pen retention system 10 generally comprises a collapsible animal cage 12 that has a plurality of walls 14. Each of the walls 14 is hingedly coupled together. Thus, the collapsible animal cage 12 is positionable in a deployed position having the collapsible animal cage 12 forming an enclosed geometric shape. Thus, the collapsible animal cage 12 may define an enclosed pen and an animal may be positioned within the enclosed pen. The animal may comprise a domesticated dog or the like.

Each of the walls 14 includes a pair of foldable sections 16. The foldable sections 16 corresponding to each of the walls 14 is coextensively aligned with each other when the corresponding wall 14 is positioned in the deployed position. The walls 14 form corners 18 of the geometric shape when the walls 14 are positioned in the deployed position. The collapsible animal cage 12 may comprise a dog exercise pen or the like.

A plurality of clips 18 is provided. Each of the clips 18 is positionable on the walls 14 when the collapsible animal cage 12 is positioned in the deployed position. Each of the clips 18 inhibits the collapsible animal cage 12 from being urged out of the deployed position. Thus, the clips 18 enhance strength of the collapsible animal cage 12.

Each of the clips 18 comprises a center face 20 extending between a first face 22 and a second face 24. The first face 22 and the second face 24 are spaced apart from each other to define a space 26 in each of the clips 18. The first face 22 has a distal edge 28 with respect to the center face 20. The distal edge 28 has a slot 30 extending upwardly toward the center face 20. The slot 30 is centrally positioned on the distal edge 28. Each of the clips 18 may have a length ranging between twenty cm and thirty cm.

Each of the clips 18 is positioned on an associated one of the walls 14. A top edge 32 of the associated wall 14 is positioned within the space 26 of an associated clip 18. Each of the walls 14 includes a hinge 34 and the hinge 34 is coupled between the foldable sections 16 of an associated wall 14. The hinge 34 corresponding to each of the walls 14 is positioned in the slot 30 when each of the clips 18 is positioned on the associated wall 14.

The plurality of clips 18 comprises a set of straight clips 36. Each of the straight clips 36 is longitudinally elongated. Each of the straight clips 36 is aligned with an intersection of the foldable sections 16 corresponding to the associated wall 14. Each of the straight clips 36 inhibit the foldable sections 16 of the associated wall 14 from being folded.

The plurality of clips 18 further comprises a set of angled clips 38. The first face 22 and the second face 24 corresponding to each of the angled clips 38 has a bend 40 thereon. The bend 40 defines a first section 42 forming an angle with a second section 44 of the corresponding angled clip 38. The slot 30 corresponding to the angled clips 18 is aligned with an intersection of the first section 42 and the second section 44. Each of the angled clips 38 is positioned on an associated one of the corners 18. Thus, each of the angled clips 38 inhibits the walls 14 from being urged out of the deployed position.

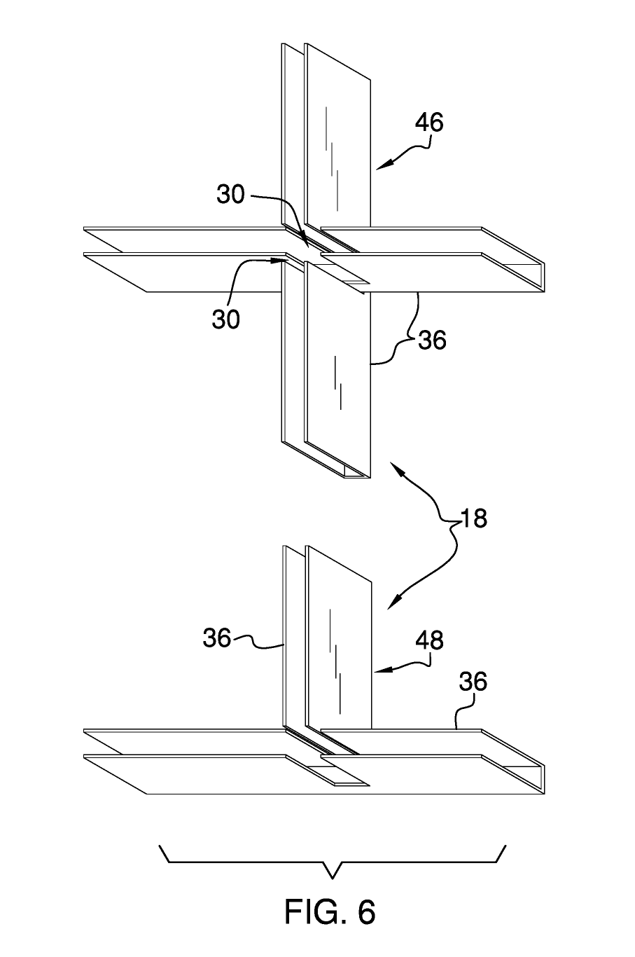

As shown in FIG. 6, the plurality of clips 18 includes a set of cross clips 46. Each of the set of cross clips 46 comprises a pair of the straight clips 36 that are coupled together. The pair of straight clips 36 corresponding to each of the set of cross clips 46 is oriented perpendicular to each other. Thus, each of the set of cross clips 46 forms a plus shape. The slot 30 associated with each of the straight clips 36 corresponding to each of the cross clips 46 are aligned with each other. Each of the set of cross clips 46 is positioned at a four way intersection of the plurality of walls 14.

As shown in FIG. 6, the plurality of clips 18 further includes a set of T-clips 48. Each of the set of T-clips 48 comprises a straight clip 36 and a lateral clip 50. The lateral clip 50 is coupled to and extends laterally away from the straight clip 36 corresponding to each of the T-clips 48. The lateral clip 50 is centrally positioned on the straight clip 36 corresponding to each of the T-clips 48. Additionally, the lateral clip 50 is oriented perpendicular to the straight clip 36 corresponding to each of the T-clips 48. Each of the T-clips 48 is positioned at a three way intersection of the plurality of walls 14

In use, the collapsible animal cage 12 is positioned in the deployed position. The collapsible animal cage 12 facilitates the enclosed pen to contain the animal. Each of the straight clips 36 is positioned on the corresponding walls 14. Each of the angled clips 38 is positioned on the corresponding corner 18. The straight clips 36 and the angled clips 38 inhibit the animal from urging the collapsible animal cage 12 out of the deployed position. Thus, the animal is inhibited from exiting the enclosed pen.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An animal pen retention system comprising:
a collapsible animal cage having a plurality of walls, each of said wall being hingedly coupled together such that said collapsible animal cage is positionable in a deployed position having said collapsible animal cage forming an enclosed geometric shape; and
a plurality of clips, each of said clips being positionable on said walls when said collapsible animal cage is positioned in said deployed position such that each of said clips inhibits said collapsible animal cage from being urged out of said deployed position.

2. The system according to claim 1, wherein each of said walls comprises a pair of foldable sections, said foldable sections corresponding to each of said walls being coextensively aligned with each other when said corresponding wall is positioned in said deployed position, said walls forming corners of said geometric shape when said walls are positioned in said deployed position.

3. The system according to claim 1, wherein each of said clips comprises a center face extending between a first face and a second face, said first face and said second face being spaced apart from each other to define a space in each of said clips, said first face having a distal edge with respect to said center face, said distal edge having a slot extending upwardly toward said center face, said slot being centrally positioned on said distal edge.

4. The system according to claim 3, wherein each of said clips is positioned on an associated one of said walls having a top edge of said associated wall being positioned within said space of an associated clip, a hinge corresponding to each of said walls being positioned in said slot when each of said clips is positioned on said associated wall.

5. The system according to claim 4, wherein said plurality of clips comprises a set of straight clips, each of said straight clips being longitudinally elongated, each of said straight clips being aligned with an intersection of said foldable sections corresponding to said associated wall, each of said straight clips being centrally positioned on said associated wall, each of said straight clips inhibiting said foldable sections of said associated wall from being folded.

6. The system according to claim 4, wherein said plurality of clips comprises a set of angled clips, each of said angled clips comprising a first section forming an angle with a second section, said slot corresponding to said angled clips being aligned with an intersection of said first section and said second section, each of said angled clips being positioned on an associated one of said corners, each of said angled clips inhibiting said walls from being urged out of said deployed position.

7. An animal pen retention system comprising:
a collapsible animal cage having a plurality of walls, each of said wall being hingedly coupled together such that said collapsible animal cage is positionable in a deployed position having said collapsible animal cage forming an enclosed geometric shape, each of said walls comprising a pair of foldable sections, said foldable sections corresponding to each of said walls being coextensively aligned with each other when said corresponding wall is positioned in said deployed position, said walls forming corners of said geometric shape when said walls are positioned in said deployed position;
a plurality of clips, each of said clips being positionable on said walls when said collapsible animal cage is positioned in said deployed position such that each of said clips inhibits said collapsible animal cage from being urged out of said deployed position, each of said clips comprising a center face extending between a first face and a second face, said first face and said second face being spaced apart from each other to define a space in each of said clips, said first face having a distal edge with respect to said center face, said distal edge having a slot extending upwardly toward said center face, said slot being centrally positioned on said distal edge, each of said clips being positioned on an associated one of said walls having a top edge of said associated wall being positioned within said space of an associated clip, a hinge corresponding to each of said walls being positioned in said slot when each of said clips is positioned on said associated wall, said plurality of clips comprising:
a set of straight clips, each of said straight clips being longitudinally elongated, each of said straight clips being aligned with an intersection of said foldable sections corresponding to said associated wall, each of said straight clips being centrally positioned on said associated wall, each of said straight clips inhibiting said foldable sections of said associated wall from being folded; and
a set of angled clips, said first face and said second face corresponding to each of said angled clips having a bend thereon to define a first section forming an angle with a second section of said corresponding angled clip, said slot corresponding to said angled clips being aligned with an intersection of said first section and said second section, each of said angled clips being positioned on an associated one of said corners, each of said angled clips inhibiting said walls from being urged out of said deployed position.
